(19) United States
(12) Patent Application Publication
(10) Pub. No.: US 2025/0252338 A1
(43) Pub. Date: Aug. 7, 2025

(54) SELF-IMPROVING ARTIFICIAL INTELLIGENCE PROGRAMMING

(71) Applicant: QUALCOMM Technologies, Inc., San Diego, CA (US)

(72) Inventors: Taco Sebastiaan COHEN, Amsterdam (NL); Corrado RAINONE, Haarlem (NL); Blazej Jakub MANCZAK, Amsterdam (NL); Wei David ZHANG, Amsterdam (NL); Michael DEFFERRARD, Chavannes-sous-Orsonnens (CH); Natasha BUTT, San Diego, CA (US)

(21) Appl. No.: 18/429,585

(22) Filed: Feb. 1, 2024

(51) Int. Cl. G06N 20/00

(52) U.S. Cl. CPC G06N 20/00

(57) ABSTRACT

Certain aspects of the present disclosure provide techniques and apparatus for improved machine learning. In an example method, a current program state comprising a set of program instructions is accessed. A next program instruction is generated using a search operation, comprising generating a probability of the next program instruction based on processing the current program state and the next program instruction using a machine learning model, and generating a value of the next program instruction based on processing the current program state, the next program instruction, and a set of alternative outcomes using the machine learning model. An updated program state is generated based on adding the next program instruction to the set of program instructions.

### INTRODUCTION

Aspects of the present disclosure relate to machine learning.

A wide variety of machine learning models have been trained for a similarly vast assortment of tasks in recent years. For example, generative models (e.g., generative adversarial models (GANs), diffusion models, large language models (LLMs), and the like) have been trained to generate new output data (e.g., images or text) based on input prompts. Recently, LLMs have undergone an explosion in relevance, and, thanks to the capability to generate and manipulate language, LLMs have been applied to a rapidly increasing set of tasks. For example, there is great interest in the possibility of these LLMs becoming capable of programming, which is a landmark task involving both language and reasoning.

In some conventional systems, these improvements have been made possible by relying on an abundance of language-based data for training (mostly produced by humans), which includes training corpora of programming code. However, it is unclear whether such human-generated corpora can be scaled up quickly enough to match the improving LLM capabilities, as training such LLMs relies on substantial (and high quality) training data. Existing training corpora may be insufficient for significant further improvements.

### BRIEF SUMMARY

Certain aspects of the present disclosure provide a processor-implemented method, comprising: accessing a current program state comprising a set of program instructions; generating a next program instruction using a search operation, comprising: generating a probability of the next program instruction based on processing the current program state and the next program instruction using a machine learning model; and generating a value of the next program instruction based on processing the current program state, the next program instruction, and a set of alternative outcomes using the machine learning model; and generating an updated program state based on adding the next program instruction to the set of program instructions.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example environment for machine-learning-based program generation, according to some aspects of the present disclosure.

FIG. 2 depicts an example system for refining machine learning models for program generation, according to some aspects of the present disclosure.

FIG. 3 is a flow diagram depicting an example method for generating programs using search operations with machine learning models, according to some aspects of the present disclosure.

FIG. 4 is a flow diagram depicting an example method for predicting probabilities and values for instructions during program generation using machine learning models, according to some aspects of the present disclosure.

FIG. 5 is a flow diagram depicting an example method for generating programs using machine learning models, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

In aspects of the present disclosure, self-improving artificial intelligence (AI) programming models are provided. In some aspects, the machine learning models described herein can be trained on their own (prior) generated programs, obviating (or at least reducing) the dependency on human-curated training data that currently limits some conventional approaches. That is, model training (e.g., for LLMs) conventionally relies on substantial amounts of training data, which may harm further innovation. Further, some conventional models are inherently limited in that the model cannot surpass its training data. That is, some conventional models (such as some LLMs) can only generate code similar to that which these models have already seen, and cannot explore new possible solutions or perform any better (e.g., to generate better programs) than the data on which these models are trained. In contrast, aspects of the present disclosure that provide for the model to be refined based on the model's own programs can result in substantially improved programming performance over time.

Further, although LLMs have improved substantially, some conventional models still generate output code one token at a time (e.g., one instruction at a time) without any deliberation, planning ahead, or backtracking. In contrast, human programmers generally think and plan ahead before actually writing code. In some aspects of the present disclosure, one or more search operations are combined with the machine-learning-based code generation in order to generate improved programming code. For example, searching operations such as a Monte Carlo tree search (MCTS) algorithm may be used to search for or identify the best next action (e.g., the program instruction that should be used next) to append to the current sequence of instructions.

In some aspects of the present disclosure, a machine learning model (e.g., a language model (LM)) may be used as to generate both the policy (e.g., the probability over next possible actions) as well as the predicted value(s) (e.g., the expected sum of future rewards for each alternative next instruction) for the searching operation. In some aspects, at each time step (e.g., for each time a “next instruction” is generated for a program), the machine learning system may prompt the LM to output the value(s) and next action (e.g., next instruction) using value and action tokens, as discussed in more detail below. In some aspects, actions are chosen from a predefined list of strings (e.g., program instructions), such as “add,” “jump,” “subtract,” and the like. In some aspects, the program instructions correspond to instructions in the assembly language (ASM).

In some aspects, the techniques described herein can be used in conjunction with expert iteration algorithm(s), where the system trains the model (e.g., the LM used to generate the policy and value) on the decoded outputs (e.g., the programs generated by the model) to order improve the model itself, as discussed in more detail below. Example Environment for Machine-Learning-Based Program Generation

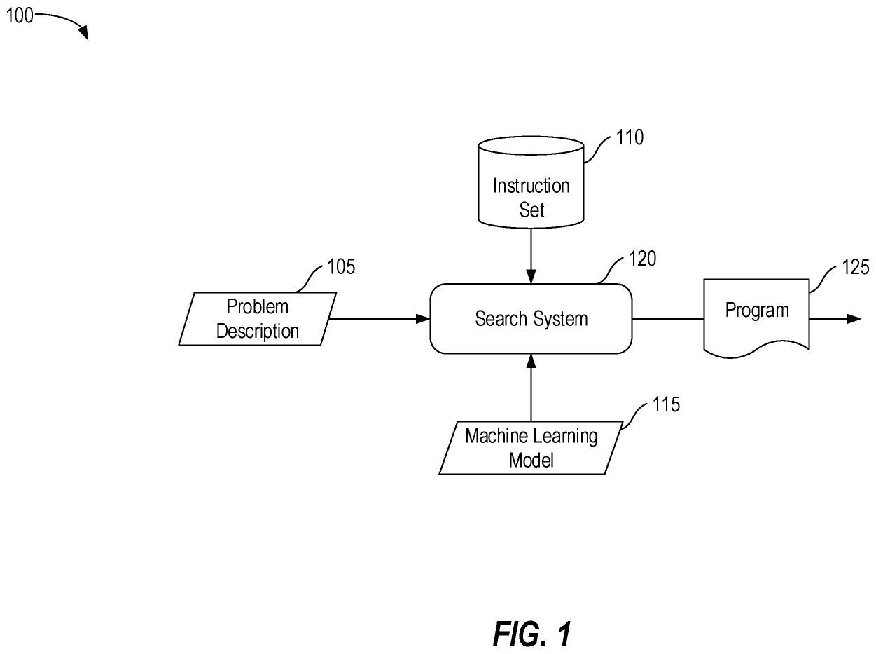

FIG. 1 depicts an example environment 100 for machine-learning-based program generation, according to some aspects of the present disclosure.

In the illustrated environment 100, a search system 120 accesses a problem description 105, an instruction set 110, and a machine learning model 115, and generates a program 125. As used herein, “accessing” data can generally include a wide variety of operations, including receiving, requesting, retrieving, generating, measuring, collecting, obtaining, or otherwise gaining access to the data. The search system 120 is generally representative of a computing system, which may be implemented using hardware, software, or a combination of hardware and software. In some aspects, the search system 120 trains the machine learning model 115. In some aspects, the search system 120 receives the trained machine learning model 115 from one or more other systems (e.g., dedicated training systems).

In the illustrated example, the problem description 105 generally describes the desired functionality of a computer program, and the program 125 is generated based on this problem description 105 to (attempt to) provide the indicated functionality. In some aspects, the problem description 105 is a textual string comprising one or more input and output pairs (e.g., where each input and output pair comprises a set of input values and a corresponding set of target output values for the program) indicating the program functionality. As one simple example, if the desired functionality is to sum the input numbers, the problem description may specify one or more input sets of numbers and one or more corresponding output sets of numbers, each output set of numbers containing the sum of the corresponding input set. For example, for an input set such as [2, 5] the corresponding output value is [7]. In some aspects, this problem description is used as input to the machine learning model 115.

In the illustrated environment 100, the machine learning model 115 can be used, by the search system 120, as the policy and the value generator for a searching operation used to generate the program 125, as discussed in more detail below. For example, for each next instruction, the search system 120 may process the problem description using the machine learning model 115 to generate a probability and a value for each instruction in the instruction set 110. In some aspects, the search system 120 further processes the current program state (e.g., the current sequence of instructions that have already been generated or selected) as input to the model (e.g., by concatenating the sequence with the problem description 105). By selecting the next instruction having the highest value (e.g., the instruction having a value greater than the predicted values of each other alternative instruction), the search system 120 may update the program state (e.g., update the sequence by concatenating the selected instruction). The search system 120 may then begin a new iteration to select a new next instruction, continuing until the program is complete (e.g., until the selected next instruction is a “terminate” instruction that signals the end of the program 125).

In some aspects, the string used to train the machine learning model 115 may specify the current program state with alternating actions (e.g., units of code, such as instructions) and outcomes (e.g., representing the results of attaching such a unit of code to the program that precedes the unit of code). For example, a string used to train the machine learning model 115 may be “inputs=[[0, 1], [4, 6]], outputs=[1, 10]O:9 A:ADD O:9 A:0 O:9 A:HLT O:9” where the problem description is “inputs=[[0, 1], [4, 6]], outputs=[1, 10]” and the program sequence includes an “ADD” instruction, an “0” instruction, and an “HLT” instruction. Further, “O” is an output or value token (indicating that the subsequent number is the value of using the corresponding action or instruction) and “A” is an action token (indicating the action taken). In some aspects, these outcome tokens and values are inserted into the sequence of actions or instructions in order to enable the model to be trained based on the string.

In some aspects, to prompt the machine learning model 115 during program generation, the input string may lack such outcome tokens. For example, suppose the search system 120 has already selected the “ADD” and “0” instructions, and is now predicting the probability that “HLT” is the next instruction. The input string may include “inputs=[[0, 1], [4, 6]], outputs=[1, 10]A:ADD A:0 A:HLT” which causes the machine learning model 115 to generate a score indicating the probability that “HLT” is the next instruction that should be added.

Similarly, to generate or predict the value of adding “HLT” to the program during program generation, the search system 120 may generate and process a set of prompt strings, one for each alternative outcome. For example, if the possible outcomes may be represented as a value of “T” to indicate that the program is truncated (e.g., program generation was terminated before a program end token was selected), a value of “S” to indicate that the program contains syntax error(s), and a set of values for integers between 0 and 9 for programs that are not truncated and do not contain errors, where the specific integer selected is determined based on the percentage of test cases for which the program generates correct output. In such an aspect, the outcome strings may include “inputs=[[0, 1], [4, 6]], outputs=[1, 10]A:ADD A:0 A:HLT O:T,” “inputs=[[0, 1], [4, 6]], outputs=[1, 10]A:ADD A:0 A:HLT O:S,” “inputs=[[0, 1], [4, 6]], outputs=[1, 10]A:ADD A:0 A:HLT O:0,” “inputs=[[0, 1], [4, 6]], outputs=[1, 10]A:ADD A:0 A:HLT 1,” and so on until “inputs=[[0, 1], [4, 6]], outputs=[1, 10]A:ADD A:0 A:HLT O:9” is generated. The search system 120 may then compute the average these alternative output predictions (e.g., of the 12 alternative outcomes), and multiply the averaged value by the predicted probability of the “HLT” instruction.

In some aspects, the search system 120 evaluates a finite set of instructions in the instruction set 110, selecting one of the instructions at each time step until the program is complete. In some aspects, the search system 120 prompts the machine learning model 115 (using the problem description 105 and the current program state) to obtain a probability distribution over possible next actions (from the instruction set 110) and next outcomes (e.g., the value of each alternative instruction in the instruction set 110). For example, given a task T and a partial program P, the probability distribution over next actions conditioned on the program generated thus far may be defined using Equation 1 below, where P(a=A|[T, P] is the probability that a is A given the task T and current program P, A is a specific action, a is random variable which may take any (allowable) value of an action (including A), LM(⋅) represents processing data·using the machine learning model 115, e(⋅) is a function which, given partial program P, outputs a string representation of the program with outcome and action markers as discussed above, [⋅] [symbol] denotes string concatenation, and A is the set of allowed code units (e.g., instructions from the instruction set 110).

$$P ( a = A \vert [ T , P ] ) ≡ \frac{LM ( [ T , e ( P ) , A : , A ] )}{{\sum }_{a ∈ 𝒜} LM ( [ T , e ( P ) , A : , a ] )} \qquad ( 1 )$$

In some aspects, once P has been generated, the search system 120 may use a variety of decoding or search strategies to generate or select the next instruction. In some aspects, an MCTS-based approach is used as the search operation. In some aspects, for example, the search system 120 generates a distribution over the next actions based on the current program state, as discussed above, where the current the state consists of the problem description 105 (e.g., input/output examples) and a partial or empty program. Based on this state, the search system 120 may initialize the root node in the search tree. Then, the search system 120 may grow the search tree one node at a time by repeating four steps. First, starting from the root node, the search system 120 successively selects a child until reaching a leaf node in the search tree (referred to in some aspects as tree traversal). Second, from this node, the search system 120 selects an action and adds the new leaf to the tree (if admissible by the environment). Third, the search system 120 estimates the value or reward at the new leaf node (using the machine learning model 115). Fourth, the search system 120 may backpropagate the new information (e.g., the value or reward at the leaf) to all nodes in the path from the new leaf node to the root.

In some aspects, during the first step, child nodes may be selected based on criteria such as the visit count per node (e.g., the number of times the child node has been selected previously), the prior probability for the next action (as predicted by the machine learning model 115), and/or the current value estimation. Such a selection process may favor actions with high prior probability that lead to children with high value, but also accounts for uncertainty in those estimates by increasing the weight of actions that have few or zero visits. For example, the search system 120 may use Equation 2 below to determine which child of the current node to select (e.g., by selecting the child having the highest score), where π′(a)=softmax(logits+π(completedQ)), logits refers to the unnormalized probabilities of each of the children nodes, completed is the action value of the child (e.g., the current value estimation of the child), N(a) is the number of times the given child a has been visited, and Σ_{b}N(b) is the sum of the number of times each other child of the same parent has been visited. By computing this value for each child of a given node, the search system 120 may select a child to visit, and repeat this evaluation for each of the next children to traverse the tree until a leaf is reached.

$${arg max}_{a} = ( {π}^{′} ( a ) - \frac{N ( a )}{1 + {\sum }_{b} N ( b )} ) \qquad ( 2 )$$

In some aspects, in the third step, the search system 120 may use an approach such as given in Equation 1 above for predicting a distribution over outcomes, which can then be averaged to get an estimate of the value of each next instruction, as discussed in more detail below. In some aspects, after repeating the four steps for a set amount of compute budget and/or a number of iterations, the result is a distribution over next actions. The search system 120 may then select the next action having the highest predicted value, and use this selected next action to continue the current program. The process is then repeated anew for the next instruction, until the program is complete.

In some aspects, to generate the probability distribution of the alternative next instructions, the search system 120 may, for each respective instruction, process the problem description 105, the current program state, and the respective instruction (e.g., as a single concatenated string) using the machine learning model 115 to generate a probability for each next instruction. This process may be performed sequentially or in parallel for each instruction. In some aspects, to generate the value prediction for each respective alternative next instruction, the search system 120 may first generate a set of intermediate values for the respective instruction, one intermediate value for each possible outcome. For example, for each respective possible outcome, the search system 120 may process the problem description 105, the current program state, the respective instruction, and the respective outcome using the machine learning model 115 to generate a probability that the respective outcome will be the result of adding the instruction. These intermediate values may then be aggregated (e.g., using a weighted averaged, where the weights of each outcome correspond to the generated probability of the outcome) in order to generate an overall value of the next instruction. In some aspects, as discussed above, this predicted value for each alternative instruction can be used to update the tree (e.g., backpropagated up the tree to the root), and the process can be repeated until the termination criteria are met. At that point, the search system 120 may select the next instruction having the highest predicted (cumulative) value.

In some aspects, as discussed above, when selecting a next action, the search system 120 can opt to end the program by selecting and appending a termination instruction. Once that happens, the program 125 is considered complete, and is ready for evaluation and/or use. In some aspects, the program 125 may be output or otherwise provided to one or more components or systems to evaluate and/or use the program 125. For example, the search system 120 may provide the program 125 to the entity that provided the problem description 105, allowing this requesting entity to test the program 125 and/or begin using the program 125 for runtime use.

In some aspects, as discussed above and in more detail below, the program 125 may be evaluated to be used to refine or update the machine learning model 115. For example, in some aspects, the evaluation may result in generating a numerical reward r(P) for the program 125, where the reward is defined based on how the program 125 performs. In some aspects, if the program reached a defined maximum length (e.g., a maximum number of instructions, such as defined by a user) before the search system 120 properly terminates the program 125 (e.g., by selecting the termination instruction) then the reward is defined as some negative number (e.g., −2).

In some aspects, if the program 125 was properly terminated by the search system 120, but the program 125 contains one or more syntax errors, the reward may be defined as a somewhat less negative number, as compared to the unfinished scenario (e.g., with a value of −1). In some aspects, if the program is syntactically correct but does not produce an output (e.g., due to a runtime error), the reward value may be similarly defined as a negative value that is somewhat larger than the unfinished program scenario (e.g., also with a value of −1).

In some aspects, if the program 125 is properly terminated by the search system 120, is syntactically correct, and produces an output when running, the reward value may be defined based on the fraction of program-produced outputs that match the outputs specified in the problem description (e.g., the input/output examples). In this case, the reward may be a value between zero (if none of the outputs are correct) and one (if all of the outputs are correct).

In some aspects, as discussed above, the search system 120 may mark the program with outcome indicators after each action, which can be used during the search operation decoding. In some aspects, these outcome values have a set of possible values (e.g., with twelve possible values). For example, a truncation error (where the program does not have a termination instruction) may result in outcome value of T (or a value of −2 for numerical purposes), a runtime or syntax error may result in outcome value of S (or a value of −1 for numerical purposes), and the rewards between zero and one (for programs that properly terminated and do not contain syntax or runtime errors) may be mapped to a set integers (e.g., between zero and nine, inclusive).

In some aspects, after the program 125 is evaluated, an outcome marker corresponding to the determined program reward may be added for each action in the program string in order to generate a training string. For example, if the program was truncated, the program string may include “O:T” after each action, while a perfect program that provides the desired functionality (or otherwise passes all tests) may include “0:9” after each action.

In some aspects, these training samples can then be stored in a buffer or storage for subsequent use in refining the machine learning model 115. For example, in some aspects, the search system 120 (or another system) may sample from the training data (e.g., in a first-in first-out manner, randomly, or using a reward-based prioritized sampling where programs with high reward values are selected more often) and update one or more parameters of the machine learning model 115 based on the sampled training strings. In this way, given a problem description and partial program, the search system 120 learns to generate a “next token” corresponding to the output values that were added to the training strings (e.g., to output a “9” when the suggested next action results in an accurate program, and a “0” when the next action results in an inaccurate program).

In this way, the machine learning model 115 can continue to learn based on its own prior-generated programs 125 which themselves were generated using a search operation (e.g., MCTS) that enables exploration of new ways to program. This may allow the search system 120 to generate programs more accurately, as well as to learn to solve more difficult problems over time, whereas conventional approaches are generally static and limited by the training samples available.

### Example System for Refining Machine Learning Models for Program Generation

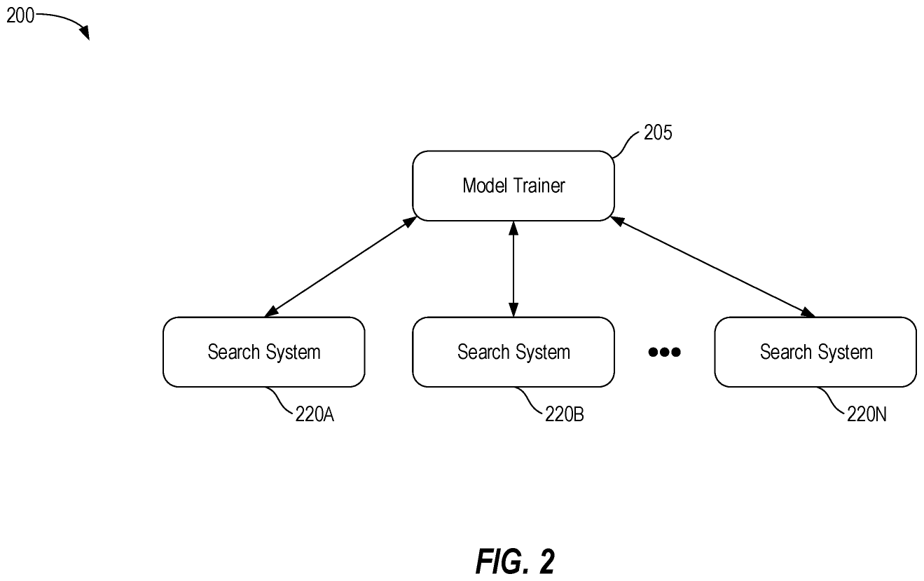

FIG. 2 depicts an example system 200 for refining machine learning models for program generation, according to some aspects of the present disclosure.

In the illustrated example, a set of search systems 220A-N are communicably coupled with a model trainer 205. In some aspects, each search system 220 corresponds to the search system 120 of FIG. 1. Each search system 220 generally corresponds to a computing system (which may be implemented using hardware, software, or a combination of hardware and software) that uses one or more search operations (e.g., MCTS) and one or more machine learning models (e.g., the machine learning model 115 of FIG. 1) to generate programs based on problem descriptions, as discussed above.

In some aspects, the model trainer 205 corresponds to a computing system (which may be implemented using hardware, software, or a combination of hardware and software) that uses exemplars (e.g., programs generated by the search system(s) 220) to update the parameters of the machine learning model(s) that the search system(s) 220 use. For example, as illustrated, the model trainer 205 may distribute the machine learning model, along with one or more problem descriptions, to a distributed set of search systems 220. Each search system 220 may then seek to generate one or more programs to provide the functionality indicated in each problem description, as discussed above. In the illustrated example, the search system(s) 220 may then return the generated programs (or training strings generated based on the programs, as discussed above) to the model trainer 205.

In some aspects, rather than the model trainer 205 distributing the problem descriptions, the search system(s) 220 may access the problem descriptions from one or more other sources. For example, in some aspects, the search systems 220 may receive the problem descriptions during runtime use (e.g., while generating programs for requesting entities, such as users or other computing systems).

In the illustrated example, the model trainer 205 uses the generated training strings to update one or more parameters of the machine learning model, as discussed above. For example, as discussed above, by using a given training string (which includes a sequence of instructions, each instruction followed by an outcome value indicating how accurately the program solves the task), the model (e.g., an LLM or LM) may learn to generate output tokens that predict the value of a given partial program. For example, when a partial program that is similar to a training string which failed to solve the task is provided, the model may tend to predict an output token with a low value. In contrast, when the partial program is similar to a successful string, the model may learn to predict an output token with a high value.

In the illustrated example, the model trainer 205 may update the machine learning model according to any suitable training criteria, such as periodically, in response to determining that a defined number of training strings have been received, and the like. In some aspects, once the model has been updated, the model trainer 205 may distribute the updated model to each participating search system 220. This allows each participating search system 220 to begin using the updated model in order to improve the system's program generation abilities.

### Example Method for Generating Programs Using Search Operations with Machine Learning Models

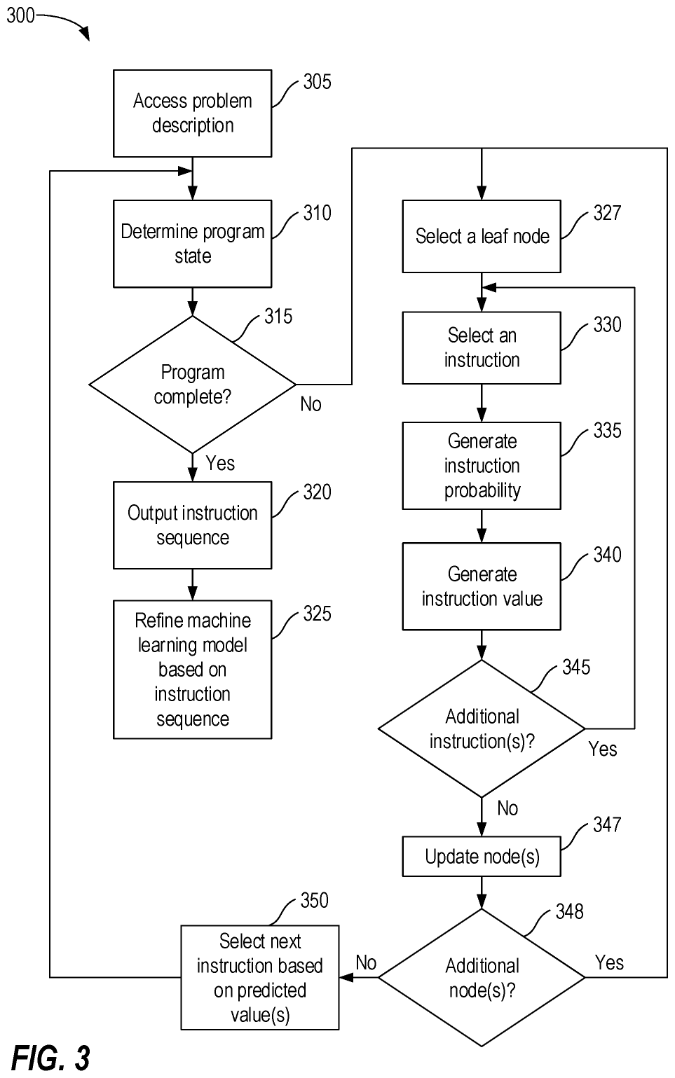

FIG. 3 is a flow diagram depicting an example method 300 for generating programs using search operations with machine learning models, according to some aspects of the present disclosure. In some aspects, the method 300 is performed by a search system, such as the search system 120 of FIG. 1 and/or a search system 220 of FIG. 2.

At block 305, the search system accesses a problem description (e.g., the problem description 105 of FIG. 1). For example, as discussed above, the problem description may be received from a user or other requesting entity, may be provided by a training system, may be retrieved from storage or memory of the search system, and the like. In some aspects, as discussed above, the problem description indicates the desired functionality of a computer program. For example, as discussed above, the problem description may comprise or correspond to a set of inputs (e.g., where input in the set of inputs comprises a set of values) and a set of outputs (e.g., where each output in the set of outputs corresponds to an input in the set of inputs, and includes a desired output value when the corresponding input is provided to the program).

At block 310, the search system determines the current program state. For example, the search system may determine the number of instructions that have been generated for the program, such as to determine whether the program has reached a defined maximum length. As another example, the search system may determine whether the last instruction in the current program state is a termination operation signaling the end of the program, as discussed above. In some aspects, the search system may determine whether the current program state contains one or more syntax errors.

At block 315, the search system determines whether the program is complete, based on the current program state determined at block 310. For example, as discussed above, the search system may determine whether the program has reached a defined maximum size, whether the program includes a termination token, and the like.

If the search system determines that the program is complete, the method 300 continues to block 320, where the search system outputs the sequence of instructions in the program (e.g., to a requesting entity that provided the problem description). In some aspects, prior to outputting the program, the search system may perform one or more operations to evaluate the program. For example, the search system may determine whether the program satisfies the program description (e.g., performs the desired functionality) prior to outputting the program (refraining from outputting the program if the program does not satisfy the problem description).

The method 300 then continues to block 325, where the search system (or another system) optionally refines the machine learning model based on the instruction sequence. For example, as discussed above, the search system may evaluate the program to determine whether the program provides the desired functionality as indicated in the problem description. The search system may then generate a reward for the program as discussed above, and update the program string to add outcome values after each action token (e.g., to indicate the determined reward). This training string can then be used to refine the model, as discussed above.

Returning to block 315, if the search system determines that the program is not complete (e.g., because the program is smaller than the maximum length and/or does not end in a termination token), the method 300 continues to block 327, where the search system selects a leaf node for evaluation. In some aspects, as discussed above, each node in the search tree corresponds to an instruction (e.g., a potential next action in the program sequence). As an example, during the first iteration of the current search operation (where only the root node exists), the search system may select the root node and evaluate each next instruction. After this first round, the search system may select one of the child nodes for evaluation, and so on (potentially generating many child nodes or levels of the tree). In some aspects, to select the node at block 327, the search system may begin at the root of the tree and successively visit child nodes (e.g., based on the visit count of each child, the instruction probability for the action that each child node corresponds to, and the current value estimation of the child nodes) until a leaf node in the search tree is encountered. In some aspects, the number of times each node has been “visited” is recorded for future updating the node values, as discussed below with reference to block 347.

Generally, the search system may sue a variety of criteria or techniques to select the leaf node. For example, as discussed above, the search system may select a leaf node from the current search tree based on factors such as the number of times that each leaf has been evaluated during the current iteration of adding a new instruction to the program, the current predicted value of the leaf, the current predicted probability of the action corresponding to the leaf, and the like. As discussed above, in some aspects, the search system may iteratively evaluate leaf nodes during a tree search operation until defined termination criteria are met. This allows the search system to explore various programming paths until the criteria are met, at which point the search system selects the next action (e.g., a child of the root node) that has the highest predicted value.

In some aspects, if the selected leaf node (selected at block 327) corresponds to a completed program (e.g., the leaf node represents a program termination token), the method 300 may skip blocks 330, 335, and 340, proceeding directly to block 347.

At block 330, the search system selects an instruction (referred to in some aspects as a next program instruction) from a defined instruction set (e.g., the instruction set 110 of FIG. 1) for evaluation. In some aspects, the search system may select the instruction using any suitable criteria, including randomly or pseudo-randomly. In some aspects, selecting this next instruction represents or generates a new leaf node in the tree (e.g., a new child of the leaf node selected at block 327, such that the leaf node selected at block 327 is no longer a leaf).

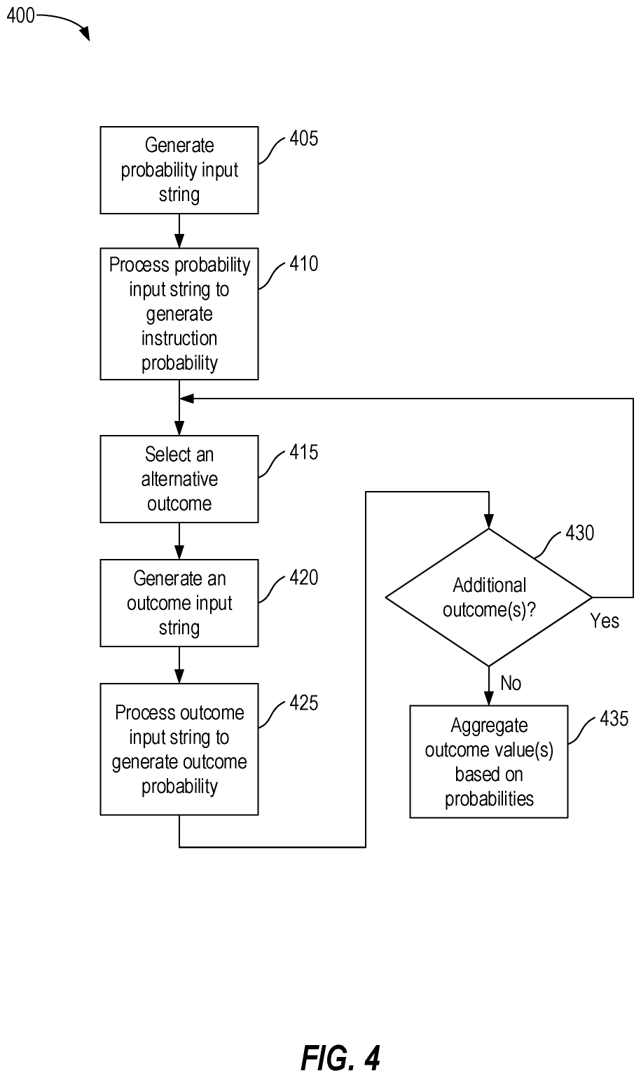

At block 335, the search system generates an instruction probability indicating the probability that the selected instruction is the best “next instruction” for the leaf node. In some aspects, as discussed above, the search system may generate this probability based on processing the problem description and/or the current program state using a machine learning model, such as the machine learning model 115 of FIG. 1. One example method for generating the probability is discussed in more detail below with reference to FIG. 4.

At block 340, the search system generates an instruction value indicating a predicted value of the selected instruction, if added to the current program state (e.g., the value of the program if the instruction selected at block 330 is added to the program). In some aspects, as discussed above, the search system may generate this predicted value based on processing the problem description and/or the current program state using a machine learning model, such as the machine learning model 115 of FIG. 1. One example method for generating the instruction value is discussed in more detail below with reference to FIG. 4.

At block 345, the search system determines whether there are additional instructions, from the instruction set, that are possible next instructions for the current program state at the current point in the tree (corresponding to the leaf node). If so, the method 300 returns to block 330. Although the illustrated method 300 depicts iteratively selecting and evaluating each instruction (e.g., sequentially), in some aspects, the search system may evaluate some or all of the instructions in parallel. For example, the machine learning model may output a probability of each next instruction in parallel based on the input(s).

If all alternative “next instructions” have been evaluated, the method 300 continues to block 347. At block 347, the search system updates one or more node(s) of the tree based on the predicted instruction value (generated at block 340). For example, as discussed above, the search system may aggregate and backpropagate the predicted value at the leaf node up the tree to the root (to all ancestors of the selected node), such that the predicted value(s) of each prior node reflect the newly predicted value of the selected leaf node. In this way, the child node of the root (which corresponds to a potential instruction that may be added to the current program) is updated to reflect the potential future value if the child node is selected for addition to the program.

In some aspects, to update the value of a given node, the search system may use Equation 3 below, where Value_{updated} is the updated value, vₚᵣᵢₒᵣ is the number of times the given node was visited prior to the current iteration, Value_{current} is the current value of the node, and Value_{child} is the value of the child of the given node which lies on the path to the leaf node selected at block 327.

$${Value}_{updated} = \frac{( {v}_{prior} * {Value}_{current} ) + ( {Value}_{child} )}{{v}_{prior} + 1} \qquad ( 3 )$$

That is, the search system may determine the current (predicted) value of the given node's child that lies on the path to the node selected at block 327 (e.g., the child on the path to the new leaf added at block 330, as discussed above). The search system can then incorporate this value into the average value of the given node over all the times the given node was visited. For example, suppose the given node has been visited four times, currently has a predicted value of 0.5, and is visited again (e.g., it is on the path from the root to the node selected at block 327). Suppose further that during the backpropagation phase, the child of the given node backpropagates a value of 0.8. In some aspects, the updated value of the given node is therefore

$$\frac{( 4 * 0.5 ) + ( 0.8 )}{5} = 0 \text{.56} .$$

At block 348, the search system determines whether to evaluate one or more additional nodes. For example, as discussed above, the search system may evaluate one or more termination criteria to determine whether a defined number of searching iterations have been performed, whether a defined amount of computing time and/or resources has been spent during the current search iteration, and the like. If not, the method 300 returns to block 327 to select another leaf node for evaluation in the current iteration.

If, at block 348, the search system determines that the termination criteria are met, the method 300 continues to block 350. At block 350, the search system selects a next instruction for the program based on the predicted values of each child node. For example, as discussed above, the search system may select the child node (e.g., from among the child nodes that are the immediate children of the current root node) having the highest predicted future value (also referred to as the probability of the node or instruction), and add this corresponding instruction to the current program state. In some aspects, this selected child becomes the new root node for the next round of the search operation, in order to select another next instruction.

The method 300 then returns to block 310 to determine the program state (e.g., to determine whether to terminate program generation).

In this way, the search system can use a tree search operation (e.g., MCTS) to iteratively evaluate alternative programming paths (e.g., sequences of nodes in the tree, where each node corresponds to a particular instruction) before selecting a single next instruction. The search system then repeats this process until the program is complete (e.g., until a terminate token is selected, or until other defined criteria are met). In this way, rather than generating the program one instruction at a time (e.g., by selecting the “best” next instruction for each time step without any deliberation, planning ahead, or backtracking), as is done in conventional systems, the search system can evaluate a variety of potential future paths for each alternative next instruction in order to select the best sequence of instructions.

### Example Method for Predicting Probabilities and Values for Instructions During Program Generation Using Machine Learning Models

FIG. 4 is a flow diagram depicting an example method 400 for predicting probabilities and values for instructions during program generation using machine learning models, according to some aspects of the present disclosure. In some aspects, the method 400 is performed by a search system, such as the search system 120 of FIG. 1 and/or a search system 220 of FIG. 2, and/or the search system discussed above with reference to FIG. 3. In some aspects, the method 400 provides additional detail for blocks 335 and 340 of FIG. 3.

At block 405, the search system generates a probability input string. That is, the search system generates an input string that can be processed as input to a machine learning model (e.g., the machine learning model 115 of FIG. 1) to prompt the model to generate a probability score indicating the probability that a specific instruction (e.g., the instruction selected at block 330 of FIG. 3) is the best “next instruction” given the current program state (which, as discussed above, includes any instructions that have already been selected for inclusion in the program, as well as any instructions along the path from the root to the leaf node that is currently being evaluated).

In some aspects, the probability input string is generated by concatenating the problem description (e.g., the problem description 105 of FIG. 1), the current program state, and the selected next instruction. For example, the probability input string may comprise “inputs=[[0, 1], [4, 6]], outputs=[1, 10]A:ADD” where the input/output pairs (e.g., the problem description) is “inputs=[[0, 1], [4, 6]], outputs=[1, 10]”, the current program state is empty (e.g., no instructions have been added yet), and the search system is querying the model to get the probability that the next instruction should be “ADD.”

At block 410, the search system processes the generated probability string using the machine learning model to generate the instruction probability for the selected instruction, as discussed above. Generally, the instruction probability is a numerical value (e.g., between zero and one).

At block 415, the search system selects an alternative outcome from the set of defined outcomes. As discussed above, the set of outcomes may correspond to the reward(s) or score(s) that may be assigned to the completed program when it is evaluated. For example, the outcomes may include twelve alternative values, such as −2 for programs that the search system does not terminate correctly, −1 for programs that contain syntax or runtime errors, and any integer between 0 and 9 (inclusive of zero and nine) indicating the percentage of input values for which the program generates correct output values. For example, the percentage of correct outputs may be mapped to an integer between 0 and 9, inclusive, such as where the reward is 0 if between 0% and 10% of the outputs are correct, the score is 1 if between 10% and 20% of the outputs are correct, and so on.

Generally, the search system may use any suitable criteria to select the alternative outcome at block 415 (including randomly or pseudo-randomly), as the search system will process all alternative outcomes during the method 400. Although the illustrated example depicts a sequential process for conceptual clarity (where each alternative is selected and evaluated in turn), in some aspects, the search system may process some or all of the alternatives in parallel.

At block 420, the search system generates an outcome input string based on the selected alternative outcome. That is, the search system generates an input string that can be processed as input to a machine learning model (e.g., the machine learning model 115 of FIG. 1) to prompt the model to generate a value score indicating the predicted value that the program will have if a specific instruction (e.g., the instruction selected at block 330 of FIG. 3) is added to the current program state (which, as discussed above, includes any instructions that have already been selected for inclusion in the program, as well as any instructions along the path from the root to the leaf node that is currently being evaluated).

In some aspects, the outcome input string is generated by concatenating the problem description (e.g., the problem description 105 of FIG. 1), the current program state, the selected next instruction, and the selected alternative outcome value. For example, the value input string may comprise “inputs=[[0, 1], [4, 6]], outputs=[1, 10]A:ADD O:5” where the input/output pairs (e.g., the problem description) is “inputs=[[0, 1], [4, 6]], outputs=[1, 10]”, the current program state is empty (e.g., no instructions have been added yet), the search system is querying the model to get the value of using “ADD” for the next instruction, and the search system is using the model to predict the probability that the value will be “5.”

At block 425, the search system processes the generated outcome string using the machine learning model to generate the outcome probability (referred to in some aspects as an intermediate value) for the selected instruction and value alternative, as discussed above. Generally, the probability is a numerical value (e.g., between zero and one).

At block 430, the search system determines whether there is at least one additional alternative outcome value that has not been evaluated. If so, the method 400 returns to block 415. If all of the alternatives have been evaluated, the method 400 continues to block 435. Although the illustrated method 400 depicts iteratively selecting and evaluating each outcome (e.g., sequentially), in some aspects, the search system may evaluate some or all of the outcomes in parallel. For example, the machine learning model may output an outcome probability of each outcome in parallel based on the input(s).

At block 435, the search system aggregates the value of each alternative outcome based on the generated intermediate value(s) (e.g., the outcome probabilities) generate for each alternative outcome. For example, as discussed above, each outcome may be associated with a numerical value or score (e.g., a score of −2 for truncation error, a score of −1 for syntax error, and a score between 0 and 9 indicating the percentage of inputs that the program accurately processes). In some aspects, the search system may weight each of these alternative outcome scores using the corresponding generated probability of the alternative outcome, and sum the resulting weighted probabilities. This aggregate value can then be used as the predicted value for the selected “next” instruction.

At block 440, the search system weights the aggregated (e.g., mean) value based on the generated probability for the selected instruction (generated at block 410). For example, the search system may multiply the aggregate value by the probability. In some aspects, this weighted aggregate value serves as the predicted value for the selected instruction. As discussed above, this weighted aggregate value can then be used to update the node(s) along the path from the selected leaf to the root (e.g., by adding the newly predicted value to the current predicted value of each such node, or by updating the average value of the node), in order to reflect the potential value of selecting each given node for addition to the program.

As discussed above, this process is generally repeated for each alternative instruction at each iteration of searching the tree (e.g., at blocks 335 and 340 of FIG. 3). After performing some number of searches, the search system can select a “next instruction” based on which child node of the root node has the highest predicted value.

### Example Method for Generating Programs Using Machine Learning Models

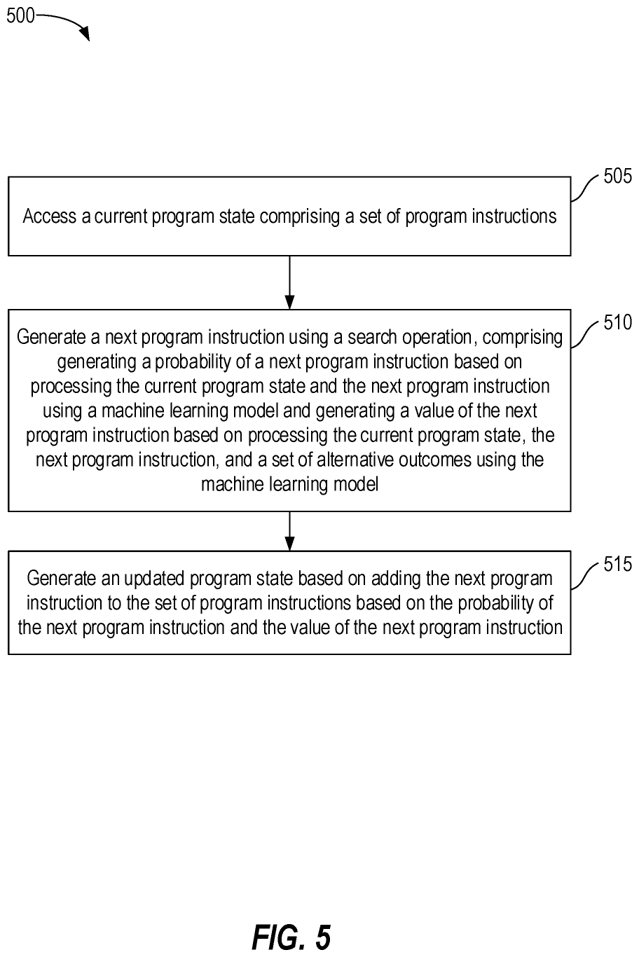

FIG. 5 is a flow diagram depicting an example method 500 for generating programs using machine learning models, according to some aspects of the present disclosure. In some aspects, the method 500 is performed by a search system, such as the search system 120 of FIG. 1 and/or a search system 220 of FIG. 2, the search system discussed above with reference to FIG. 3, and/or the search system discussed above with reference to FIG. 4.

At block 505, a current program state comprising a set of program instructions is accessed.

At block 510, a next program instruction is generated using a search operation. In some aspects, generating the next program instruction comprises generating a probability of the next program instruction based on processing the current program state and the next program instruction using a machine learning model. In some aspects, generating the next program instruction comprises generating a value of the next program instruction based on processing the current program state, the next program instruction, and a set of alternative outcomes using the machine learning model.

In some aspects, generating the value of the next program instruction includes generating, for each respective alternative outcome of the set of alternative outcomes, a respective intermediate value based on processing the current program state, the next program instruction, and the respective alternative outcome using the machine learning model, generating a mean intermediate value based on averaging the respective intermediate values for each respective alternative outcome of the set of alternative outcomes, and weighting the mean intermediate value using the probability of the next program instruction to generate the value of the next program instruction.

In some aspects, generating the next program instruction further includes generating a respective value of each respective program instruction of the set of program instructions, and selecting the next program instruction in response to determining that the value of the next program instruction is greater than the respective values of each other program instruction of the set of program instructions.

In some aspects, generating the next program instruction is based further on processing a problem description describing desired functionality of a computer program using the machine learning model.

In some aspects, the problem description comprises a set of input values and a corresponding set of target output values for the computer program.

At block 515, an updated program state is generated based on adding the next program instruction to the set of program instructions.

In some aspects, the method 500 further includes generating another next program instruction using the search operation, and generating another updated program state based on adding the other next program instruction to the set of program instructions.

In some aspects, the method 500 further includes, in response to determining that the updated program state satisfies a program description describing desired functionality of a computer program, outputting the set of program instructions.

In some aspects, the method 500 further includes updating one or more parameters of the machine learning model based on the set of program instructions to generate an updated machine learning model.

In some aspects, the method 500 further includes generating another set of program instructions using the updated machine learning model.

In some aspects, the search operation comprises a Monte Carlo tree search (MCTS) operation.

In some aspects, the machine learning model comprises a large language model (LLM).

### Example Processing System for Machine Learning

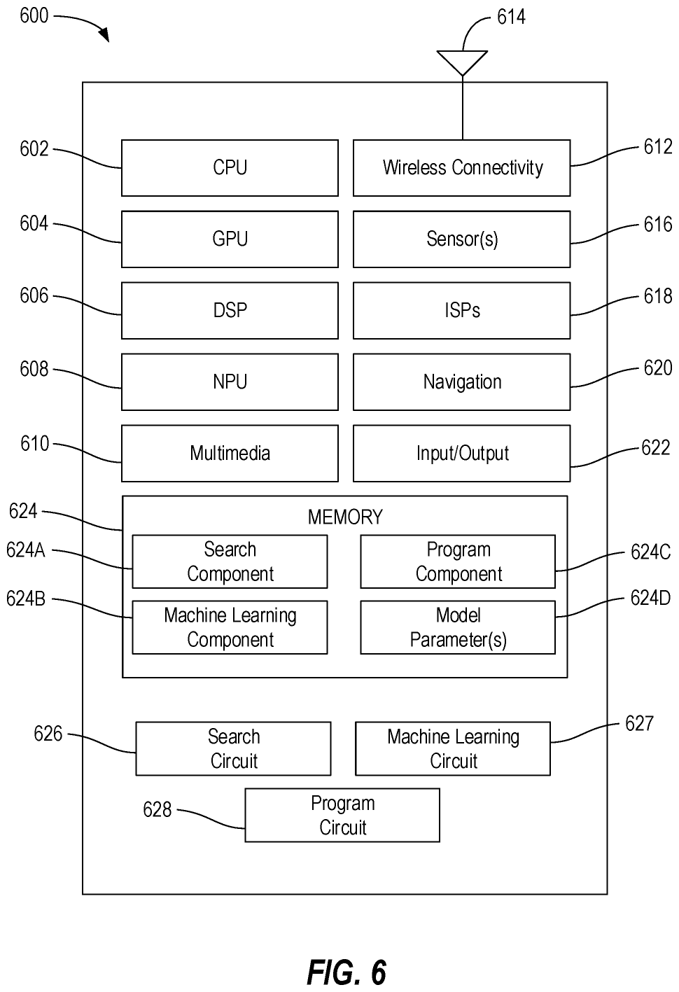

FIG. 6 depicts an example processing system 600 configured to perform various aspects of the present disclosure, including, for example, the techniques and methods described with respect to FIGS. 1-5. In some aspects, the processing system 600 may correspond to a search system. For example, the processing system 600 may correspond to the search system 120 of FIG. 1, a search system 220 of FIG. 2, the search system discussed above with reference to FIG. 3, the search system discussed above with reference to FIG. 4, and/or the search system discussed above with reference to FIG. 5. Although depicted as a single system for conceptual clarity, in some aspects, as discussed above, the operations described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a search component 624A, a machine learning component 624B, and a program component 624C. Although not depicted in the illustrated example, the memory 624 may also include other components, such as an inferencing or generation component to manage the generation of programs using trained machine learning models, a training component used to train or update the machine learning model(s), and the like. Though depicted as discrete components for conceptual clarity in FIG. 6, the illustrated components (and others not depicted) may be collectively or individually implemented in various aspects.

As illustrated, the memory 624 also includes a set of model parameters 624D (e.g., parameters of one or more machine learning models or components thereof). For example, the model parameters 624D may include parameters for the machine learning model 115 of FIG. 1. Although not depicted in the illustrated example, the memory 624 may also include other data such as training data (e.g., programs represented as text strings, which may include programs generated by the processing system 600 itself).

The processing system 600 further comprises a search circuit 626, a machine learning circuit 627, and a program circuit 628. The depicted circuits, and others not depicted (such as an inferencing circuit), may be configured to perform various aspects of the techniques described herein.

The search component 624A and/or the search circuit 626 may be used to perform search operations in order to evaluate alternative program instructions in order to select a “next” instruction to add to a current program, as discussed above. For example, the search component 624A and/or the search circuit 626 may use a tree-based search such as MCTS to iteratively evaluate different programming paths in order to select which next instruction results in the highest predicted value.

The machine learning component 624B and/or the machine learning circuit 627 may be used to predict the probability and/or value of adding a given next instruction to the program, as discussed above. For example, at each iteration, the machine learning component 624B and/or the machine learning circuit 627 may be used to generate predicted probabilities for each alternative instruction, as well as predicted value(s) of adding each alternative next instruction, using one or more machine learning models (e.g., an LLM).

The program component 624C and/or the program circuit 628 may be used to generate programs (e.g., the program 125 of FIG. 1) based on the search and/or may evaluate generated programs, as discussed above. For example, the program component 624C and/or the program circuit 628 may use the selected program instructions to generate an actual program that can be executed, and/or may use input/output pairs to evaluate the performance of the programs such that the programs can be used to refine the machine learning models, as discussed above.

Though depicted as separate components and circuits for clarity in FIG. 6, the search circuit 626, the machine learning circuit 627, and the program circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, aspects of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 maybe distributed between multiple devices.

### Example Clauses

Implementation examples are described in the following numbered clauses:

Clause 1: A method, comprising: accessing a current program state comprising a set of program instructions; generating a next program instruction using a search operation, comprising: generating a probability of the next program instruction based on processing the current program state and the next program instruction using a machine learning model; and generating a value of the next program instruction based on processing the current program state, the next program instruction, and a set of alternative outcomes using the machine learning model; and generating an updated program state based on adding the next program instruction to the set of program instructions.

Clause 2: A method according to Clause 1, wherein generating the value of the next program instruction comprises: generating, for each respective alternative outcome of the set of alternative outcomes, a respective intermediate value based on processing the current program state, the next program instruction, and the respective alternative outcome using the machine learning model; generating a mean intermediate value based on averaging the respective intermediate values for each respective alternative outcome of the set of alternative outcomes; and weighting the mean intermediate value using the probability of the next program instruction to generate the value of the next program instruction.

Clause 3: A method according to any of Clauses 1-2, wherein generating the next program instruction further comprises: generating a respective value of each respective program instruction of the set of program instructions; and selecting the next program instruction in response to determining that the value of the next program instruction is greater than the respective values of each other program instruction of the set of program instructions.

Clause 4: A method according to any of Clauses 1-3, further comprising: generating another next program instruction using the search operation; and generating another updated program state based on adding the other next program instruction to the set of program instructions.

Clause 5: A method according to any of Clauses 1-4, further comprising, in response to determining that the updated program state satisfies a program description describing desired functionality of a computer program, outputting the set of program instructions.

Clause 6: A method according to any of Clauses 1-5, wherein generating the next program instruction is based further on processing a problem description describing desired functionality of a computer program using the machine learning model.

Clause 7: A method according to Clause 6, wherein the problem description comprises a set of input values and a corresponding set of target output values for the computer program.

Clause 8: A method according to any of Clauses 1-7, further comprising updating one or more parameters of the machine learning model based on the set of program instructions to generate an updated machine learning model.

Clause 9: A method according to Clause 8, further comprising generating another set of program instructions using the updated machine learning model.

Clause 10: A method according to any of Clauses 1-9, wherein the search operation comprises a Monte Carlo tree search (MCTS) operation.

Clause 11: A method according to any of Clauses 1-10, wherein the machine learning model comprises a large language model (LLM).

Clause 12: A processing system comprising: a memory comprising computer-executable instructions; and one or more processors configured to execute the computer-executable instructions and cause the processing system to perform a method in accordance with any of Clauses 1-11.

Clause 13: A processing system comprising means for performing a method in accordance with any of Clauses 1-11.

Clause 14: A non-transitory computer-readable medium comprising computer-executable instructions that, when executed by one or more processors of a processing system, cause the processing system to perform a method in accordance with any of Clauses 1-11.

Clause 15: A computer program product embodied on a computer-readable storage medium comprising code for performing a method in accordance with any of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access a current program state comprising a set of program instructions;
generate a next program instruction using a search operation, wherein, to generate the next program instruction, the one or more processors are configured to execute the processor-executable instructions and cause the processing system to:
generate a probability of the next program instruction based on processing the current program state and the next program instruction using a machine learning model; and
generate a value of the next program instruction based on processing the current program state, the next program instruction, and a set of alternative outcomes using the machine learning model; and
generate an updated program state based on adding the next program instruction to the set of program instructions.

2. The processing system of claim 1, wherein to generate the value of the next program instruction, the one or more processors are configured to execute the processor-executable instructions and cause the processing system to:
generate, for each respective alternative outcome of the set of alternative outcomes, a respective intermediate value based on processing the current program state, the next program instruction, and the respective alternative outcome using the machine learning model;
generate a mean intermediate value based on averaging the respective intermediate values for each respective alternative outcome of the set of alternative outcomes; and
weight the mean intermediate value using the probability of the next program instruction to generate the value of the next program instruction.

3. The processing system of claim 1, wherein to generate the next program instruction, the one or more processors are configured to further execute the processor-executable instructions and cause the processing system to:
generate a respective value of each respective program instruction of the set of program instructions; and
select the next program instruction in response to determining that the value of the next program instruction is greater than the respective values of each other program instruction of the set of program instructions.

4. The processing system of claim 1, wherein the one or more processors are configured to further execute the processor-executable instructions and cause the processing system to
generate another next program instruction using the search operation; and
generate another updated program state based on adding the other next program instruction to the set of program instructions.

5. The processing system of claim 1, wherein the one or more processors are configured to further execute the processor-executable instructions and cause the processing system to, in response to determining that the updated program state satisfies a program description describing desired functionality of a computer program, output the set of program instructions.

6. The processing system of claim 1, wherein, to generate the next program instruction, the one or more processors are configured to further execute the processor-executable instructions and cause the processing system to process a problem description describing desired functionality of a computer program using the machine learning model.

7. The processing system of claim 6, wherein the problem description comprises a set of input values and a corresponding set of target output values for the computer program.

8. The processing system of claim 1, wherein the one or more processors are configured to further execute the processor-executable instructions and cause the processing system to update one or more parameters of the machine learning model based on the set of program instructions to generate an updated machine learning model.

9. The processing system of claim 8, wherein the one or more processors are configured to further execute the processor-executable instructions and cause the processing system to generate another set of program instructions using the updated machine learning model.

10. The processing system of claim 1, wherein the search operation comprises a Monte Carlo tree search (MCTS) operation.

11. The processing system of claim 1, wherein the machine learning model comprises a large language model (LLM).

12. A processor-implemented method of program generation, comprising:
accessing a current program state comprising a set of program instructions;
generating a next program instruction using a search operation, comprising:
generating a probability of the next program instruction based on processing the current program state and the next program instruction using a machine learning model; and
generating a value of the next program instruction based on processing the current program state, the next program instruction, and a set of alternative outcomes using the machine learning model; and
generating an updated program state based on adding the next program instruction to the set of program instructions.

13. The method of claim 12, wherein generating the value of the next program instruction comprises:
generating, for each respective alternative outcome of the set of alternative outcomes, a respective intermediate value based on processing the current program state, the next program instruction, and the respective alternative outcome using the machine learning model;
generating a mean intermediate value based on averaging the respective intermediate values for each respective alternative outcome of the set of alternative outcomes; and
weighting the mean intermediate value using the probability of the next program instruction to generate the value of the next program instruction.

14. The method of claim 12, wherein generating the next program instruction further comprises:
generating a respective value of each respective program instruction of the set of program instructions; and
selecting the next program instruction in response to determining that the value of the next program instruction is greater than the respective values of each other program instruction of the set of program instructions.

15. The method of claim 12, further comprising:
generating another next program instruction using the search operation; and
generating another updated program state based on adding the other next program instruction to the set of program instructions.

16. The method of claim 12, further comprising, in response to determining that the updated program state satisfies a program description describing desired functionality of a computer program, outputting the set of program instructions.

17. The method of claim 12, wherein generating the next program instruction is based further on processing a problem description describing desired functionality of a computer program using the machine learning model.

18. The method of claim 17, wherein the problem description comprises a set of input values and a corresponding set of target output values for the computer program.

19. The method of claim 12, further comprising updating one or more parameters of the machine learning model based on the set of program instructions to generate an updated machine learning model.

20. The method of claim 19, further comprising generating another set of program instructions using the updated machine learning model.
